(19) United States
(12) Patent Application Publication
(10) Pub. No.: US 2026/0196152 A1
(43) Pub. Date: Jul. 9, 2026

(54) ELECTRONIC DEVICE

(71) Applicant: Innolux Corporation, Miaoli County (TW)

(72) Inventors: Chih-Chin Kuo, Miaoli County (TW); Jin Yi Tan, Miaoli County (TW); Ying-Jen Chen, Miaoli County (TW)

(73) Assignee: Innolux Corporation, Miaoli County (TW)

(21) Appl. No.: 19/414,154

(22) Filed: Dec. 9, 2025

Related U.S. Application Data
(60) Provisional application No. 63/742,835, filed on Jan. 7, 2025.

(30) Foreign Application Priority Data
Sep. 22, 2025 (CN) 202511357082.X

(51) Int. Cl. G09G 3/02; G02F 1/13; G02F 1/1335; G09G 3/36

(52) U.S. Cl. CPC G09G 3/02; G02F 1/1323; G02F 1/133512; G02F 1/133514; G09G 3/3607; G09G 3/3614; G09G 2320/028; G09G 2320/068; G09G 2358/00

(57) ABSTRACT

An electronic device includes a display panel unit and a functional panel unit. The display panel unit has a display region and a non-display region adjacent to the display region. The display panel unit includes a first light shielding element disposed in the non-display region. The functional panel unit is disposed on the display panel unit and has an active region and a non-active region adjacent to the active region. The functional panel unit includes a second light shielding element disposed in the non-active region. In a cross-sectional direction of the electronic device, a width of the first light shielding element is greater than a width of the second light shielding element.

### CROSS-REFERENCE TO RELATED APPLICATION

This application claims the priority benefit of U.S. provisional application Ser. No. 63/742,835, filed on Jan. 7, 2025, and China application serial no. 202511357082.X, filed on Sep. 22, 2025. The entirety of each of the above-mentioned patent applications is hereby incorporated by reference herein and made a part of this specification.

### BACKGROUND

### Technical Field

The disclosure relates to an electronic device.

### Description of Related Art

In response to the increasing demand for additional display functions in electronic devices, the electronic devices have evolved from having a single panel to having multiple panels. For example, through disposing a functional panel unit on a display panel unit, different display requirements may be met, such as switching between two-dimensional images and three-dimensional images and switching between different display viewing angles. However, distances between two stacked panels and a light emitting surface are different, resulting in different sizes in display regions when viewing the electronic device from the front and from the side, affecting viewing experience.

### SUMMARY

The disclosure provides an electronic device that helps to enhance viewing experience.

In an embodiment of the disclosure, the electronic device includes a display panel unit and a functional panel unit. The display panel unit has a display region and a non-display region adjacent to the display region. The display panel unit includes a first light shielding element disposed in the non-display region. The functional panel unit is disposed on the display panel unit and has an active region and a non-active region adjacent to the active region. The functional panel unit includes a second light shielding element disposed in the non-active region. In a cross-sectional direction of the electronic device, a width of the first light shielding element is greater than a width of the second light shielding element.

In order for the features and advantages of the disclosure to be more comprehensible, the following specific embodiments are described in detail in conjunction with the drawings.

### BRIEF DESCRIPTION OF THE DRAWINGS

FIG. 1 to FIG. 3 are respectively partial cross-sectional schematic diagrams of three electronic devices according to some embodiments of the disclosure.

### DESCRIPTION OF THE EMBODIMENTS

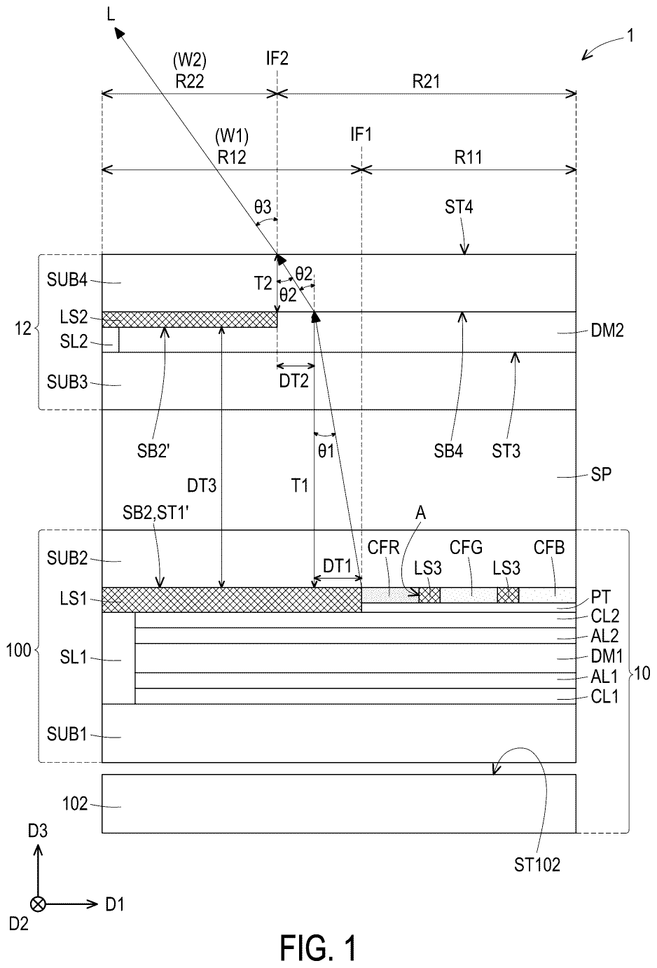

Please refer to FIG. 1. An electronic device 1 may include a display panel unit 10 and a functional panel unit 12. The display panel unit 10 has a display region R11 and a non-display region R12 adjacent to the display region R11. The display panel unit 10 includes a first light shielding element LS1 disposed in the non-display region R12. The functional panel unit 12 is disposed on the display panel unit 10 and has an active region R21 and a non-active region R22 adjacent to the active region R21. The functional panel unit 12 includes a second light shielding element LS2 disposed in the non-active region R22. In a cross-sectional direction (for example, a direction D1) of the electronic device 1, a width W1 of the first light shielding element LS1 is greater than a width W2 of the second light shielding element LS2.

In detail, the display panel unit 10 may be configured to provide a display light L with display information (for example, color, grayscale, or a combination thereof). The display region R11 of the display panel unit 10 refers to a region in the display panel unit 10 that is mainly configured to output the display light L, and the region may be a middle/central region of the display panel unit 10. On the other hand, the non-display region R12 of the display panel unit 10 refers to a region in the display panel unit 10 that is mainly configured to dispose peripheral circuits or other elements (for example, drivers, etc.) or film layers that are not intended to be visible to a user, and the region may be an edge region of the display panel unit 10 and may be located on one side or more sides of the display region R11. When the top view shape of the display region R11 is a quadrilateral, the non-display region R12 may be located on one side, two sides, three sides, or four sides of the display region R11. When the non-display region R12 is located on four sides of the display region R11, it may be regarded as that the non-display region R12 surrounds the display region R11.

The non-self-luminous display module 100 is disposed on a transmission path of the light emitted by the light source module 102 to convert the light into the display light L with the display information. Taking FIG. 1 as an example, a top surface ST102 of the light source module 102 (surface of the light source module 102 adjacent to the non-self-luminous display module 100) is, for example, a light emitting surface, and the light emitted by the light source module 102 is, for example, emitted from the top surface ST102 of the light source module 102. The non-self-luminous display module 100 is, for example, disposed above the top surface ST102 of the light source module 102 to receive the light emitted by the light source module 102 and convert the light into the display light L.

In some embodiments, the non-self-luminous display module 100 may be a liquid crystal display module, and as shown in FIG. 1, in addition to the first light shielding element LS1, the non-self-luminous display module 100 may further include a first substrate SUB1 (also referred to as a “lower substrate” of the display panel unit 10), a second substrate SUB2 (also referred to as an “upper substrate” of the display panel unit 10), a third light shielding element LS3, multiple color filter patterns (for example, a red color filter pattern CFR, a green color filter pattern CFG, and a blue color filter pattern CFB), a protective layer PT, a first circuit layer CL1, a second circuit layer CL2, a first alignment layer AL1, a second alignment layer AL2, a first display medium layer (for example, a liquid crystal layer) DM1, and a sealant SL1, but not limited thereto. The non-self-luminous display module 100 may further include other elements or film layers according to different requirements.

The first substrate SUB1, the second substrate SUB2, the third substrate SUB3, and the fourth substrate SUB4 may both be light transmitting substrates. The first substrate SUB1, the second substrate SUB2, the third substrate SUB3, and the fourth substrate SUB4 may be a hard substrate or a flexible substrate. The materials of the first substrate SUB1, the second substrate SUB2, the third substrate SUB3, and the fourth substrate SUB4 include, for example, glass, quartz, ceramic, sapphire, plastic, or adhesive, but not limited thereto.

The first substrate SUB1 and the second substrate SUB2 are disposed opposite to each other and overlap with each other in a direction (for example, a direction D3) in which the display panel unit 10 and the functional panel unit 12 are stacked. The first light shielding element LS1 is, for example, disposed on a lower surface SB2 of the second substrate SUB2 (that is, a surface of the second substrate SUB2 facing the first substrate SUB1). The first light shielding element LS1 and the second light shielding element LS2 may be formed of a light absorbing material to reduce visibility of underlying elements or film layers. The material of the second light shielding element LS2 may be the same as or different from the material of the first light shielding element LS1. The light absorbing material may include a black photoresist, but not limited thereto.

In some embodiments, the top view shape of the first light shielding element LS1 may be a frame shape, wherein an inner edge of the first light shielding element LS1 forms a boundary IF1 between the display region R11 and the non-display region R12, the display region R11 is within the boundary IF1, and the non-display region R12 is from the boundary IF1 to the edge of the electronic device 1. The first light shielding element LS1 may entirely cover the non-display region R12, so that in the cross-sectional direction (for example, the direction D1) of the electronic device 1, the width W1 of the first light shielding element LS1 is equal to the width of the non-display region R12.

The third light shielding element LS3 is disposed in the display region R11 and is also, for example, disposed on the lower surface SB2 of the second substrate SUB2. The third light shielding element LS3 may also include a light absorbing material to reduce visibility of the underlying elements or film layers.

In some embodiments, the top view shape of the third light shielding element LS3 may be a grid shape and may have multiple openings A arranged in the direction D1 and/or a direction D2. The direction D1 and the direction D2 intersect each other and are both perpendicular to the direction D3.

Multiple color filter patterns (for example, the red color filter pattern CFR, the green color filter pattern CFG, and the blue color filter pattern CFB) are respectively disposed in the openings A of the third light shielding element LS3, and the color filter patterns of different colors are, for example, alternately disposed along the direction D1, but not limited thereto. In other embodiments not shown, two adjacent color filter patterns may extend onto the third light shielding element LS3, and two adjacent color filter patterns may contact or overlap with each other. For example, the adjacent red color filter pattern CFR and green color filter pattern CFG may extend onto the third light shielding element LS3 between the red color filter pattern CFR and the green color filter pattern CFG, and the red color filter pattern CFR and the green color filter pattern CFG may overlap with each other, wherein the red color filter pattern CFR may be between the green color filter pattern CFG and the third light shielding element LS3 or the green color filter pattern CFG may be between the red color filter pattern CFR and the third light shielding element LS3.

The protective layer PT is disposed on the third light shielding element LS3 and the color filter patterns and is disposed between the third light shielding element LS3 and the second circuit layer CL2.

The second circuit layer CL2 and the second alignment layer AL2 are sequentially disposed on a surface of the protective layer PT facing the first substrate SUB1, and the first circuit layer CL1 and the first alignment layer AL1 are sequentially disposed on a surface of the first substrate SUB1 facing the second substrate SUB2. For example, the first circuit layer CL1 may include a structure in which multiple conductive layers and multiple insulating layers are alternately disposed and a pixel electrode. The second circuit layer CL2 may include a common electrode.

The first display medium layer DM1 is disposed between the first alignment layer AL1 and the second alignment layer AL2, and the first display medium layer DM1 is sealed between the first substrate SUB1 and the second substrate SUB2 by the sealant SL1. Through changing a voltage difference between the pixel electrode and the common electrode to change a tilting direction of liquid crystal molecules in the first display medium layer DM1, a polarization direction of light passing through the first display medium layer DM1 may be changed. Although not shown in FIG. 1, the non-self-luminous display module 100 may further include a lower polarizer and an upper polarizer, wherein the lower polarizer is disposed on a lower surface of the first substrate SUB1 (that is, a surface of the first substrate SUB1 away from the second substrate SUB2), the upper polarizer is disposed on an upper surface of the second substrate SUB2 (that is, a surface of the second substrate SUB2 away from the first substrate SUB1), and the lower polarizer and the upper polarizer may have transmission axes that are perpendicular to each other or parallel to each other. Through controlling the voltage difference in combination with the disposition of the lower polarizer and the upper polarizer, the transmittance of the display light L output from the non-self-luminous display module 100 may be changed.

Although the display panel unit 10 in FIG. 1 is exemplified by the non-self-luminous display panel unit, it should be understood that the display panel unit herein may be of other types of architectures without having the light source module 102, such as a self-luminous display panel unit or a reflective display panel unit. In addition, a pixel definition layer for reducing light mixing and/or for shielding side light leakage in the organic light emitting diode display panel unit or the micro light emitting diode display panel unit may serve as the first light shielding element herein. The material of the pixel definition layer may include a white, gray, or black organic polymer material, but not limited thereto.

The functional panel unit 12 is disposed on a transmission path of the display light L from the display panel unit 10 to change a light emission angle or a range of the light emitting device 1. Taking FIG. 1 as an example, the functional panel unit 12 and the display panel unit 10 are disposed opposite to each other and overlap with each other in the direction D3. In some embodiments not shown, the functional panel unit 12 may be fixed onto the display panel unit 10 through an adhesive layer or a mechanical member. The adhesive layer may be coated only around a space SP between the functional panel unit 12 and the display panel unit 10, and the space SP between the functional panel unit 12 and the display panel unit 10 may include an air gap or a vacuum space. Alternatively, the adhesive layer may fill the space SP between the functional panel unit 12 and the display panel unit 10, and there may be no air gap or vacuum space present in the space SP between the functional panel unit 12 and the display panel unit 10.

According to different requirements, the functional panel unit 12 may be a two-dimensional/three-dimensional image switching unit for switching between two-dimensional images and three-dimensional images or a viewing angle adjustment unit for switching between different display viewing angles. Taking FIG. 1 as an example, in addition to the second light shielding element LS2, the functional panel unit 12 may further include a third substrate SUB3 (also referred to as a “lower substrate” of the functional panel unit 12), a fourth substrate SUB4 (also referred to as an “upper substrate” of the functional panel unit 12), a second display medium layer DM2, and a sealant SL2, but not limited thereto. The functional panel unit 12 may further include other elements or film layers according to different requirements.

In some embodiments, the top view shape of the second light shielding element LS2 may be a frame shape, wherein an inner edge of the second light shielding element LS2 forms a boundary IF2 between the active region R21 and the non-active region R22, the active region R21 is within the boundary IF2, and the non-active region R22 is from the boundary IF2 to the edge of the electronic device 1. The second light shielding element LS2 may entirely cover the non-active region R22, so that in the cross-sectional direction (for example, the direction D1) of the electronic device 1, the width W2 of the second light shielding element LS2 is equal to the width of the non-active region R22.

The second display medium layer DM2 is sealed between the third substrate SUB3 and the fourth substrate SUB4 by the sealant SL2, and the second light shielding element LS2 is, for example, disposed between the fourth substrate SUB4 and the sealant SL2. When the second display medium layer DM2 includes liquid crystal molecules, although not shown, the functional panel unit 12 may further include a lower circuit layer and an upper circuit layer, wherein the lower circuit layer is disposed on an upper surface ST3 of the third substrate SUB3, the upper circuit layer is disposed on the lower surface SB4 of the fourth substrate SUB4 and is disposed in the active region R21, and the second display medium layer DM2 is disposed between the lower circuit layer and the upper circuit layer.

In an embodiment where the functional panel unit 12 is a viewing angle adjustment unit, through changing a voltage difference between the lower circuit layer and the upper circuit layer to change the tilting direction of the liquid crystal molecules in the second display medium layer DM2, the transmittance or the light divergence of the second display medium layer DM2 may be changed, so as to implement switching between different display viewing angles (for example, a narrow viewing angle and a wide viewing angle).

In the embodiment where the functional panel unit 12 is a two-dimensional/three-dimensional image switching unit, although not shown, the functional panel unit 12 may further include a lens layer disposed in the active region R21 and disposed between the upper circuit layer and the second display medium layer DM2. The lens layer may include multiple micro lenses (for example, hemispherical lenses, but not limited thereto). The microlenses are, for example, arranged along the direction D1, and an extension direction of the microlenses may be parallel to the direction D2. Alternatively, the extension direction of the microlenses may be non-parallel and non-perpendicular to the direction D1 and the direction D2, but may form an angle with the direction D2, which is not limited here. Through changing the voltage difference between the lower circuit layer and the upper circuit layer to change the tilting direction of the liquid crystal molecules in the second display medium layer DM2, the effective refractive index of the second display medium layer DM2 may be changed, so as to implement switching between two-dimensional images and three-dimensional images.

Alternatively, the second display medium layer DM2 may include other polymer materials, such as liquid crystal polymer (LCP), but not limited thereto.

In the embodiment of the disclosure, through enabling the width W2 of the second light shielding element LS2 to be less than the width W1 of the first light shielding element LS1, the second light shielding element LS2 may reduce the shielding or the absorption of the display light L obliquely incident on the functional panel unit 12, allowing the user to receive the display light L output from the edge of the display region R11 when viewing the electronic device 1 from both the front and the side. In this way, the issue of the display region being reduced due to the display light L output from the edge of the display region R11 being shielded by the second light shielding element LS2 when the electronic device 1 is viewed from the side may be improved, thereby improving viewing experience.

As shown in FIG. 1, the width difference between the second light shielding element LS2 and the first light shielding element LS1 (for example, |W1−W2|, that is, the distance between the boundary IF1 and the boundary IF2) is equal to the sum of a distance DT1 and a distance DT2. The distance DT1 is equal to T1*tanθ1, where T1 is the distance from the lower surface SB4 of the fourth substrate SUB4 to the lower surface SB2 of the second substrate SUB2, and θ1 is the incidence angle of the display light L at the lower surface SB4 of the fourth substrate SUB4. The distance DT2 is equal to T2*tanθ2, where T2 is the thickness of the fourth substrate SUB4, and θ2 is the incidence angle of the display light L at an upper surface ST4 of the fourth substrate SUB4. According to the Fresnel equation, n1*sinθ1=n2*sinθ2, and n2*sinθ2=n3*sinθ3, where n1 is the equivalent refractive index between a lower surface SB2′ of the second light shielding element LS2 and an upper surface ST1′ of the first light shielding element LS1, n2 is the refractive index of the fourth substrate SUB4, n3 is the refractive index of air (n3 is, for example, 1), and θ3 is a preset side display viewing angle. From the above equations, it may be deduced that: θ1=sin⁻¹[(n2*sinθ2)/n1], and θ2=sin⁻¹[(sinθ3)/n2]. Therefore, |W1−W2|=DT1+DT2=T1*tan{sin⁻¹[(n2*sinθ2)/n1]}+T2*tan{sin⁻¹[(sinθ3)/n2]}.

In actual products, the width difference (|W1−W2|) between the second light shielding element LS2 and the first light shielding element LS1, the distance T1, the thickness T2, the refractive index n2, the incidence angle θ2, and the side display viewing angle θ3 are measurable. Substituting the measured values into the above equation, the equivalent refractive index n1 between the lower surface SB2′ of the second light shielding element LS2 and the upper surface ST1′ of the first light shielding element LS1 may be derived. In some embodiments, the equivalent refractive index n1 between the lower surface SB2′ of the second light shielding element LS2 and the upper surface ST1′ of the first light shielding element LS1 may fall within a range of 1 to 3.

In some embodiments, the fourth substrate SUB4 may be a composite substrate formed by stacking multiple materials. For example, the fourth substrate SUB4 may include multiple of a light transmitting substrate, an anti-reflection layer, an anti-fouling layer, and an anti-scratch layer. In an embodiment where the fourth substrate SUB4 is a composite substrate formed by stacking multiple materials, n2 is the equivalent refractive index of the fourth substrate SUB4, and n2 may fall within a range of 1 to 3.

In some embodiments, glass, polyethylene terephthalate, cellulose triacetate, an optically clear adhesive, an optically clear resin, polymethyl methacrylate, polystyrene, or a combination thereof may be included between the lower surface SB2′ of the second light shielding element LS2 and the upper surface ST1′ of the first light shielding element LS1. For example, as shown in FIG. 1, the second display medium layer DM2, the third substrate SUB3, the space SP, and the second substrate SUB2 may be included between the lower surface SB2′ of the second light shielding element LS2 and the upper surface ST1′ of the first light shielding element LS1. In some embodiments, although not shown, the space SP may include or be provided with a substrate to maintain the distance between the display panel unit 10 and the functional panel unit 12 and/or increase the overall stiffness of the electronic device 1. In some embodiments, although not shown, the space SP may further include or be provided with an adhesive layer for fixing the substrate to the second substrate SUB2 or the third substrate SUB3.

In some embodiments, air or a vacuum space may be present between the lower surface SB2′ of the second light shielding element LS2 and the upper surface ST1′ of the first light shielding element LS1. For example, as described above, when the adhesive layer or the mechanical member for fixing the functional panel unit 12 and the display panel unit 10 is only disposed around the space SP between the functional panel unit 12 and the display panel unit 10, the space SP may include an air gap or a vacuum space.

In some embodiments, a distance DT3 between the lower surface SB2′ of the second light shielding element LS2 and the upper surface ST1′ of the first light shielding element LS1 may be greater than 0.01 mm.

In some embodiments, the transmittance of visible light from the lower surface SB2′ of the second light shielding element LS2 to the upper surface ST1′ of the first light shielding element LS1 may be greater than or equal to 80% and less than or equal to 99.9%.

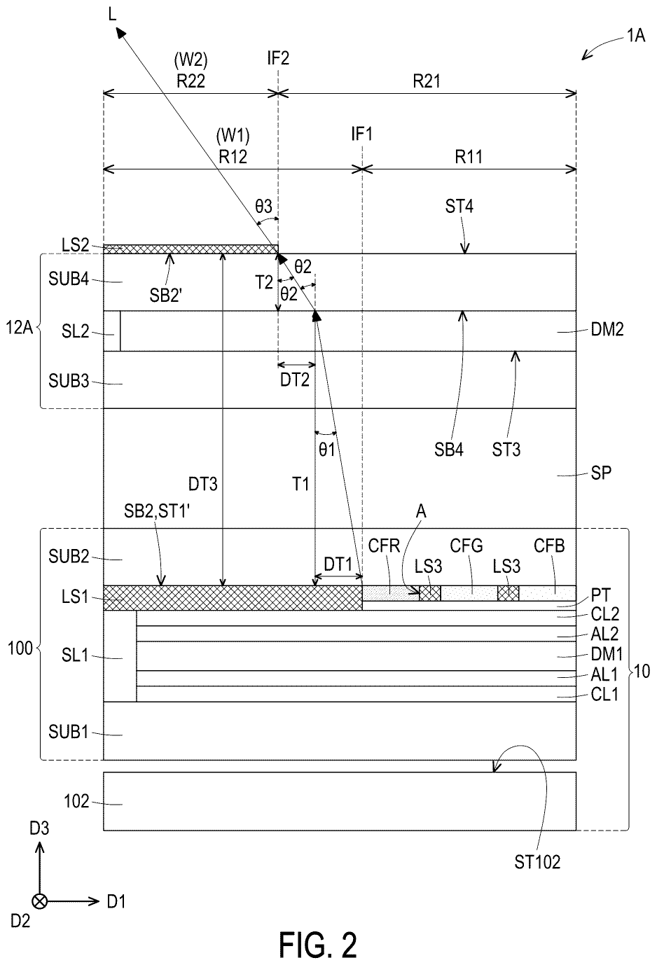

Please refer to FIG. 2. The main difference between an electronic device 1A and the electronic device 1 of FIG. 1 lies in the disposition position of the second light shielding element LS2. Specifically, in a functional panel unit 12A of the electronic device 1A, the second light shielding element LS2 is disposed on the upper surface ST4 of the fourth substrate SUB4, and the fourth substrate SUB4 is, for example, disposed between the second light shielding element LS2 and the sealant SL2. Furthermore, the distance DT3 between the lower surface SB2′ of the second light shielding element LS2 and the upper surface ST1′ of the first light shielding element LS1 is, for example, greater than the distance T1 from the lower surface SB4 of the fourth substrate SUB4 to the lower surface SB2 of the second substrate SUB2. In addition, in addition to the second display medium layer DM2, the third substrate SUB3, the space SP, and the second substrate SUB2, the fourth substrate SUB4 is also included between the lower surface SB2′ of the second light shielding element LS2 and the upper surface ST1′ of the first light shielding element LS1.

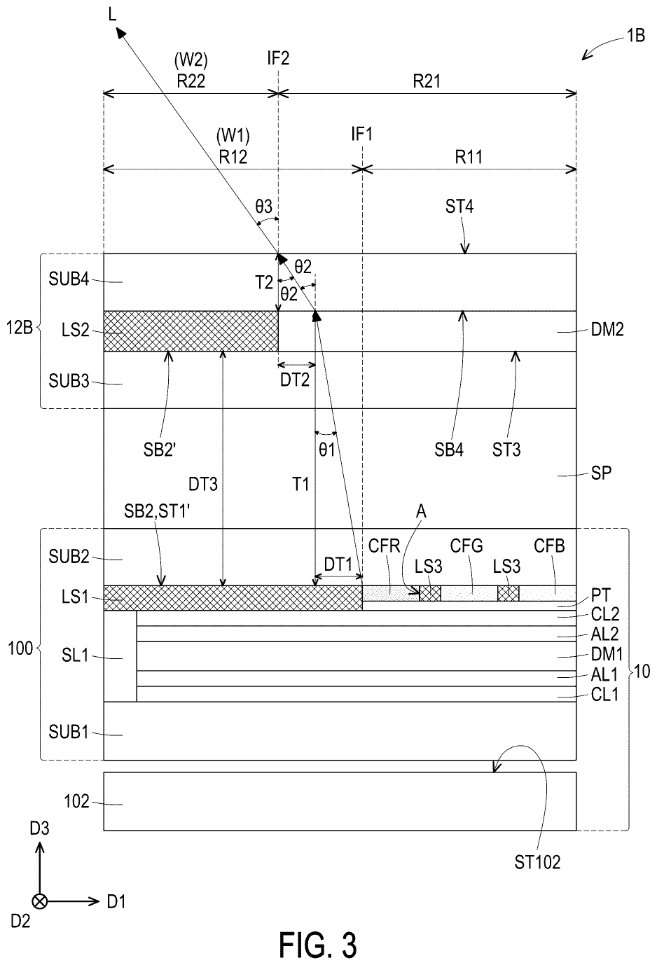

Please refer to FIG. 3. The main difference between an electronic device 1B and the electronic device 1 of FIG. 1 lies in that the second light shielding element LS2 is a spacer disposed between two substrates (that is, the third substrate SUB3 and the fourth substrate SUB4) of the functional panel unit 12. Specifically, in a functional panel unit 12B of the electronic device 1B, the thickness of the second light shielding element LS2 is equal to the distance between the third substrate SUB3 and the fourth substrate SUB4. The second light shielding element LS2 may replace the sealant SL2 (see FIG. 1 or FIG. 2) to seal the second display medium layer DM2 between the third substrate SUB3 and the fourth substrate SUB4, so as to save the cost of manufacturing the sealant SL2 or omit the process of manufacturing the sealant SL2. The material of the second light shielding element LS2 may include a light absorbing adhesive, and the color of the second light shielding element LS2 may be similar to or the same as the color of the first light shielding element LS1 to reduce the color difference between the first light shielding element LS1 and the second light shielding element LS2. Furthermore, the distance DT3 between the lower surface SB2′ of the second light shielding element LS2 and the upper surface ST1′ of the first light shielding element LS1 is, for example, less than the distance T1 from the lower surface SB4 of the fourth substrate SUB4 to the lower surface SB2 of the second substrate SUB2. In addition, the third substrate SUB3, the space SP, and the second substrate SUB2 may be included between the lower surface SB2′ of the second light shielding element LS2 and the upper surface ST1′ of the first light shielding element LS1, but the second display medium layer DM2 is not included.

In summary, in the embodiments of the disclosure, through enabling the width of the first light shielding element to be greater than the width of the second light shielding element (that is, enabling the width of the second light shielding element to be less than the width of the first light shielding element), the user may view the display regions of the same or similar sizes when viewing the electronic device from the front and from the side, thereby improving viewing experience.

What is claimed is:

1. An electronic device, comprising:
a display panel unit, having a display region and a non-display region adjacent to the display region, wherein the display panel unit comprises a first light shielding element disposed in the non-display region; and
a functional panel unit, disposed on the display panel unit and having an active region and a non-active region adjacent to the active region, wherein
the functional panel unit comprises a second light shielding element disposed in the non-active region, and
in a cross-sectional direction of the electronic device, a width of the first light shielding element is greater than a width of the second light shielding element.

2. The electronic device according to claim 1, wherein glass, polyethylene terephthalate, cellulose triacetate, an optically clear adhesive, an optically clear resin, polymethyl methacrylate, polystyrene, or a combination thereof is comprised between a lower surface of the second light shielding element and an upper surface of the first light shielding element.

3. The electronic device according to claim 1, wherein an equivalent refractive index between a lower surface of the second light shielding element and an upper surface of the first light shielding element falls within a range of 1 to 3.

4. The electronic device according to claim 1, wherein air or a vacuum space is present between a lower surface of the second light shielding element and an upper surface of the first light shielding element.

5. The electronic device according to claim 1, wherein a distance between a lower surface of the second light shielding element and an upper surface of the first light shielding element is greater than 0.01 mm.

6. The electronic device according to claim 1, wherein the functional panel unit is a two-dimensional/three-dimensional image switching unit for switching between a two-dimensional image and a three-dimensional image.

7. The electronic device according to claim 1, wherein the functional panel unit is a viewing angle adjustment unit for switching between different display viewing angles.

8. The electronic device according to claim 1, wherein the second light shielding element is disposed on a lower surface of an upper substrate of the functional panel unit.

9. The electronic device according to claim 1, wherein the second light shielding element is disposed on an upper surface of an upper substrate of the functional panel unit.

10. The electronic device according to claim 1, wherein the second light shielding element is a spacer disposed between two substrates of the functional panel unit.

11. The electronic device according to claim 10, wherein a material of the second light shielding element comprises a light absorbing adhesive.

12. The electronic device according to claim 10, wherein a color of the second light shielding element is similar to or the same as a color of the first light shielding element.

13. The electronic device according to claim 1, wherein the second light shielding element is disposed between an upper substrate of the functional panel unit and a sealant of the functional panel unit.

14. The electronic device according to claim 1, wherein the first light shielding element is disposed between an upper substrate of the display panel unit and a sealant of the display panel unit.

15. The electronic device according to claim 14, wherein the display panel unit further comprises:
a third light shielding element, disposed in the display region, wherein the first light shielding element and the third light shielding element are both disposed on a lower surface of the upper substrate of the display panel unit.

16. The electronic device according to claim 15, wherein the first light shielding element and the third light shielding element have different thicknesses.

17. The electronic device according to claim 15, wherein the third light shielding element has a plurality of openings, and the display panel unit further comprises:
a plurality of color filter patterns, respectively disposed in the openings.

18. The electronic device according to claim 1, wherein the first light shielding element covers the non-display region and exposes the display region.

19. The electronic device according to claim 1, wherein the second light shielding element covers the non-active region and exposes the active region.

20. The electronic device according to claim 1, wherein the first light shielding element partially overlaps with the active region.
